(19) United States
(12) Patent Application Publication
(10) Pub. No.: US 2017/0025989 A1
(43) Pub. Date: Jan. 26, 2017

(54) A POLE MOUNTABLE SOLAR TRACKING DEVICE

(71) Applicant: Solar Sure Pty Ltd, St. Lucia (AU)

(72) Inventor: Ian Henry Shaw, St. Lucia (AU)

(21) Appl. No.: 15/125,046

(22) PCT Filed: Mar. 12, 2015
(86) PCT No.: PCT/AU2015/000136

§ 371 Date: Sep. 9, 2016

(30) Foreign Application Priority Data
Mar. 12, 2014 (AU) 2014900848

(51) Int. Cl. H02S 20/32; F24J 2/52; H02S 40/44; F24J 2/54; H02S 30/10; H02S 40/22

(52) U.S. Cl. CPC H02S 20/32; H02S 30/10; H02S 40/22; H02S 40/44; F24J 2/5413; F24J 2/523; F24J 2/5264; F24J 2002/5437; F24J 2002/5486

(57) ABSTRACT

A pole mounted dual axis solar tracking apparatus has a main mounting member [13] in a fixed primary north-south axis which is inclined to accommodate geographical latitude and a cross arm [16] fixed to the main mounting member and defining a secondary east-west axis. A support frame [15] for PV panels, solar reflectors etc. is pivoted to the cross arm to enable the support frame to tilt over the secondary east-west axis. The apparatus is highly efficient due to its ability to sweep through the shape of two conjoined cones. The apparatus operates with close to the efficiency of a dual axis tracker but with the simplicity of a single axis tracker.

### TECHNICAL FIELD

The present invention is directed to a solar tracking apparatus that can be mounted to the top of a pole and which can track the Sun's pathway across the sky and can make adjustments depending on the season. The apparatus can support PV panels, solar reflectors, panels for solar hot water and the like

### BACKGROUND

Any references to methods, apparatus or documents of the prior art are not to be taken as constituting any evidence or admission that they formed, or form part of the common general knowledge.

It is known that better efficiency can be obtained from PV panels if the panels can track the Sun. Thus, single axis solar tracking devices are well-known. These devices usually enable the panels to rotate about a north-south axis, and therefore in an east-west direction.

It is known to incline the axis depending on the latitude thereby enabling the angle of the PV panels to the Sun to be maximized.

It is also known to adjust the tilt of the panels according to the season. In latitudes north and south of the equator, such “seasonal” adjustments can provide further improvements in panel efficiency.

Thus, it is known to provide dual axis solar trackers to enable the PV panels to rotate about a north-south axis (the primary axis) and also enable the PV panels to rotate or tilt about an east-west axis (the secondary axis) to adjust for seasons. As an example, the PV panels will be more inclined about the secondary axis during winter and less inclined about the secondary axis during summer.

It is known to mount a solar tracker on top of a pole. There are various advantages in doing so including reduced unauthorized access to the PV panels, less shading issues, better traffic access and maneuverability for servicing and mowing, wider range of options in terms of land use under the arrays, the panels can be held much higher which means in areas where dust storms are common, less damage is done by sand blasting, the height can also provide clearance advantages helping to clear structures or vegetation,

There are however some disadvantages with existing pole mounted trackers, and especially dual axis pole mounted trackers.

Many pole mounted trackers rotate the PV array from east to west by rotation about a vertical axis in line with the axis of the pole. The panels array is inclined and rotates about the vertical axis from the east to the west. This is expensive and the drive motors are prone to damage.

Other existing dual axis pole mounted trackers have two actuators constantly adjusting to accurately follow the sun. These dual axis trackers, while being efficient are prone to damage due to wind forces.

Single axis pole mounted trackers are known and are less complex in manufacture and assembly but are not as efficient. Some trackers can have an adjustable tilt angle but this adjustment occurs to the angle of the tilted north south axis.

Many pole mounted trackers have the tilting mechanism to one side of the pole axis which places an uneven load to one side of the pole. The pole and tracker requires reinforcement to overcome the imbalance and this adds to weight and cost. There would be an advantage to provide a tracker that better balanced or centered the load on top of the pole and not to one side.

Another difficulty with solar trackers mounted onto poles is in providing a robust drive mechanism to drive the quite heavy combination of the solar panels, the support frame for the panels and the tracker mechanism, and to protect the drive mechanism against damage caused, inter alia, by wind load on the array translating stresses and forces to the drive mechanism.

Existing centrally supported trackers such as pole mounted trackers have reasonable tracking efficiency but high construction and maintenance costs due to structural complexity. A highly efficient tracking pathway is to be able to sweep the shape of two conjoined cones. There would be an advantage to provide a pole mounted tracker that could sweep this shape.

There would be an advantage if it were possible to provide a pole mounted tracking apparatus which operates with close to the efficiency of a dual axis tracker but with the simplicity of a single axis tracker and which is a relatively inexpensive structure.

It is an object of the present invention to provide a pole mounted tracker which could overcome at least some of the abovementioned disadvantages or provide a useful and commercial choice in the marketplace.

### SUMMARY OF THE INVENTION

According to a first aspect of the present invention there is provided a solar tracking apparatus mountable at the top of an upright support, the apparatus comprising:
A main mounting member adapted for rotation relative to the upright support about an inclined primary axis defining a north south axis;
a support frame adapted to support PV panels;
attachment means to attach the support frame to the main mounting member;
pivot means to enable the support frame to pivot relative to the attachment means about a secondary axis defining an east west axis; and,
adjustment means to enable the tilt angle of the support frame to the attachment means to be adjusted.

In a preferred non-limiting embodiment of the invention, the attachment means comprises a cross arm defining the secondary axis, the pivot means comprise pins at opposed ends of the cross arm and to which the panel support frame can be pivotally mounted, and the adjustment means comprises a tilt adjusting drive that can adjust the tilt angle of the support frame (and therefore the panels) to accommodate the different pathways of the Sun between winter and summer.

An advantage of this particular apparatus is that it becomes possible to provide a pole mounted tracking apparatus which operates with close to the efficiency of a dual axis tracker but the simplicity of a single axis tracker.

The design enables a PV array supported by the apparatus to sweep the shape of two conjoined cones. No other centrally supported tracker does this. FIG. 2A illustrates a non-limiting embodiment of this.

The upright support will typically comprise a pole, mast, tower or something similar. It is common to use the term “pole” in respect of this type of upright support and therefore throughout the specification, the term “pole” will be used but it should be understood that the term is meant to encompass any tall upright structure on which the apparatus can be fixed and which provides the advantages described above.

The length of the upright support can vary; however the length should be such that the erection of the upright support is relatively straightforward, and the PV panels and tracking apparatus can be fitted, inspected, maintained and repaired without incurring unnecessary costs. Therefore, it is envisaged that the upright support will typically have a length of between 2-8 m.

The upright support can be made of any suitable material. It is envisaged that the upright support will comprise tubular steel, but there may be circumstances where it is more convenient for the upright support to be manufactured from reinforced concrete. There may also be circumstances where the upright support is manufactured from steel plates mounted together and reinforced by cross members. It is not envisaged that any unnecessary limitation should be placed on the invention in the manufacture of the upright support.

It is preferred that the main mounting member is fixed or substantially fixed at an angle depending on the geographical latitude where the apparatus is to be installed. For example, in most instances, the main mounting member will have a fixed downward tilt (towards the equator) of between 18°-25°. This adjustment in the latitude improves the correct positioning of the panels relative to the Sun.

It is preferred that the angle of the mounting member (to accommodate for latitude) is provided by a correctly inclined upper part of the pole. Thus, the upper part of the pole may be provided with a mount about which the main mounting member can rotate, the mount on top of the pole being at the correct angle. The mount on top of the pole may comprise a hinge, shaft or axle or something similar about which the main mounting member can rotate.

The angle of the mount may be initially adjustable to accommodate for latitude and then fixed into the correct tilt angle. Alternatively, the mount on the upper part of the pole is removably mounted to the remainder of the pole. In this manner, when a pole mounted tracking apparatus according to the invention is to be erected at a particular latitude, the correctly inclined mount can be selected and attached to the top of the pole and the main mounting member of the solar tracking apparatus can then be rotatably attached to the mount. Other assembly alternatives are envisaged. For instance, the main mounting assembly of the solar tracking apparatus can be preassembled to a mount having a desired angle (depending on latitude) and this can be fitted to the top of the pole by any suitable means.

The mount on top of the pole is suitably orientated along the north-south (primary) axis as well as being inclined downwardly (towards the equator) depending on the particular latitude where the apparatus is to be used. Thus, mounting of the main mounting member to the mount on top of the pole will cause the main mounting member to rotate about the primary axis and also have the correct “latitude” inclination.

The mount on top of the pole may comprise part of a hinge with the main mounting member comprising the other parts of a hinge. A nonlimiting example of this is illustrated in FIG. 12.

The mount on top of the poll may be bifurcated to present two or more arm members which can support a hinge to enable the main mounting member to rotate.

Other types of mount are envisaged.

The solar tracking apparatus is therefore mounted to the top of an upright pole to rotate about a north south axis.

The main mounting member in the solar tracking apparatus may comprise an elongate member. The elongate member typically comprises strong rigid steel or something similar. The elongate member may be fitted to the mount on top of the pole via bearings. The elongate member may be solid or hollow. The elongate member may have a length of between 10 to 120 cm although this can vary to suit. The elongate member may comprise end walls containing recesses or sockets to accommodate bearings, and a main body portion extending between the end walls. FIGS. 1A-1C illustrate some nonlimiting embodiments of this type of elongate member.

However, the main mounting member need not be limited to that described above. For instance, the main mounting member may comprise a strong rigid plate like member typically formed from metal such as aluminium or steel. The plate like member may be provided with knuckles to accommodate a hinge pin to enable the main mounting member to rotate.

An attachment means is provided which is connected to the main mounting member. Suitably, the attachment means is mounted directly to the main mounting member however there may be circumstances where there is an advantage in providing some form of intermediate member. It is however preferred in all cases that the attachment means is fixed against any movement relative to the main mounting member. That is, rotation of the main mounting member causes rotation of the attachment means but the attachment means is unable to move independently of the main mounting member.

The attachment means suitably comprises at least one cross arm. Suitably, a single cross arm is provided that extends laterally across the main mounting member and typically at right angles to the main mounting member. It is also envisaged that the attachment means may comprise a first arm member extending outwardly from one side of the main mounting member and a second arm member extending outwardly from the other side of the main mounting member. The first arm member and the second arm member may be formed separately and attached to the main mounting member. Each arm member may extend substantially in a common plane, or may extend upwardly and outwardly.

Pivot means is provided and which defines a secondary east-west axis. The pivot means will typically be on the support frame and/or the attachment means and arranged in such a manner to define the east-west axis. Thus, if the attachment means comprises a single cross member, it is envisaged that each end of the cross member will contain pivot means and the pivot means will be aligned to form the secondary axis. It is envisaged that the pivot means will comprise a pivot pin or something similar about which the support frame can pivot. Alternatively, the pivot means may comprise recesses and the support frame may comprise pins which can fit into the recesses—again to pivot the support frame (and therefore the PV panels) about the secondary east-west axis. It is also considered that other types of arrangements could be used to enable the PV panels to be hinged or pivoted about the east-west axis relative to the main mounting member and in such a manner that the panels will still rotate upon rotation of the main mounting member.

Some form of support frame is provided to enable PV panels to be fitted. The support frame may comprise any arrangement of elongate rigid members which can be connected to each other in any manner to provide a strong rigid frame to which the PV panels can be attached. The size of the frame can vary, inter alia, depending on the number of PV panels to be fitted, the size of the panels and the like. The shape of the frame can also vary to suit. It is however envisaged that the frame will be substantially rectangular and will have a length of between 2-15 m and a width of between 2-8 m such that between 4 and 40 panels can be supported. This can of course vary to suit and the dimensions provided above are meant to be illustrative only of the invention and not limiting. For circular or elliptical collectors or reflectors other frame shape would be preferred.

The solar array and the support frame and panels is preferably “balanced” about the pivot means.

The support frame can support PV panels however it is also envisaged that the solar tracking apparatus can be used to support other panels or components that can benefit from solar tracking. For instance, the solar tracking apparatus may be suitable for use with heating a liquid such as water or heating a gas. The apparatus can also be used to support solar reflectors (such as mirrors) to concentrate the sun's rays onto a central collector.

The type, size, manufacture and output of the PV panels can of course vary and may include polycrystalline panels, monocrystalline panels, thin film solar panels. These panels typically have an output of between 100-400 watts, but it is envisaged that panel efficiency will greatly improve in the future. It is not considered that the solar tracking apparatus should be limited to any type of PV panel and should also include other devices (such as solar water heaters) that can benefit from solar tracking.

The apparatus includes adjustment means to enable the tilt angle (and therefore the angle of the panels) to be adjusted about the secondary axis. This adjustment can accommodate the different Sun tracking pathways between summer and winter such that the panels maintain an approximately correct orientation relative to the Sun.

The adjustment means is suitably mounted to, or relative to the main mounting member such that it rotates with rotation of the main mounting member. This can simplify construction while maintaining efficiency. FIGS. 4 and 7 illustrate non-limiting embodiments of adjustment means mounted to a depending arm (30) which rotates with the main mounting member.

FIGS. 1A and 1B illustrate non-limiting embodiments where the adjustment means is attached to a semicircular toothed rack (55) which rotates with the main mounting member.

The adjustment means may comprise a tilt adjusting drive to enable the tilt angle of the PV panels to be adjusted about the secondary east-west axis.

The tilt adjusting drive may comprise a linear actuator.

FIGS. 8-11 illustrate non-limiting embodiments of tilt adjusting drives.

The drive may comprise a threaded rod. The threaded rod may be protected within a housing. A travelling nut may be threadingly attached to the threaded rod such that rotation of the rod in one direction causes the nut to advance along the rod and rotation of the rod in the other direction causes the nut to retreat. FIG. 10 illustrates a non-limiting embodiment of such a drive.

At least one connecting member may be provided between the nut and the support frame. The at least one connecting member may comprise a bracing arm. Suitably, a pair of connecting members is provided. Travel of the nut along the threaded rod can cause pivoting of the support frame about the east-west axis.

The threaded rod may be associated with some form of handle to enable the rod to be manually rotated. The handle may comprise a wheel attached to the lower end of the threaded rod. Alternatively, the handle may comprise a knob that can be rotated. In a further alternative, the lower end of the threaded rod may be associated with a fixture to enable a tool to rotate the threaded rod. The fixture may comprise a socket or a projection that can engage with a tool. The tool can be operated manually from the ground (as an example only) to enable the tilt of the panels to be adjusted periodically (for instance, monthly).

In yet a further alternative, a fixed nut or similar can be welded or otherwise fixed to the rod and a spanner used to rotate the nut and therefore the rod into and out of a threaded socket to extend and retract the tilt adjusting drive. FIG. 8 illustrates a non-limiting embodiment of such a drive.

It is envisaged that the adjustment means may be automated. In one form, a drive means such as a motor can be used to rotate the rod. FIG. 9 illustrates a non-limiting embodiment of such a drive.

In another form, the adjustment means may be incrementally adjusted in a mechanical manner which can simplify the mechanism as additional electric motors etc. are not required.

In one such form, the incremental adjustment may be carried out by contact of part of the adjustment means with another stationery part of the apparatus or pole. As the adjustment means is connected to the main mounting member it rotates with the main mounting member about the primary north-south axis and can be made to contact a non-moving part of the apparatus to incrementally adjust the adjustment means. Suitably, the adjustment means comprises a threaded rod with a travelling nut as described above, and part of the threaded rod is fixed to a toothed gear which can contact a cam or pawl or other type of projection to incrementally rotate the gear (and therefore the rod) for instance on a daily basis. FIG. 10 illustrates a non-limiting embodiment of such a drive.

It is envisaged that more than one tilt adjustment means may be provided. These may comprise any combination of that described above. FIG. 11 illustrates a nonlimiting embodiment of an apparatus comprising a pair of tilt adjustment means.

Suitably, the pivot means to enable the support frame to pivot relative to the attachment means about a secondary axis defining an east west axis is such that the secondary axis intersects, or is close to, the vertical longitudinal axis of the pole. It is further preferred that the support frame and the attachment means and any attached PV panels are designed such that the weight is evenly distributed to each side of the secondary axis, or put differently, that the array is balanced on top of the pole.

A drive means is typically provided to drive the apparatus about the primary north-south axis. The drive means suitably has a particular structure to provide the apparatus with more stability particularly in windy conditions. Therefore, in one form, the drive means may comprise a toothed rack and a motor. The rack may be attached to the attachment means (the attachment means typically comprising a cross arm) at spaced apart locations which can provide two lateral points of robust support of the rack. The rack is suitably semicircular in configuration. A shaft of the motor may be coupled to the rack by a cog whereby rotation of the cog causes the rack to travel. Alternatively the motor may be coupled by a worm drive which meshes with the outside (convex) part of the rack. Suitably, the motor is fixed or mounted to the upright support.

Other types of drive means are envisaged to drive the array over the north-south primary axis. These may include various types of actuators including linear actuators.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1A and 1B. Illustrate a side view of an array driven about the N-S axis using a semicircular rack.

FIG. 10. Illustrates a side view of main elements of an alternative embodiment and showing the fixed tilt primary axis/hinge and a cross section of the shaft representing the secondary axis over which inclination is adjusted.

FIG. 2A. Illustrates a top view of array on a midwinters day turning from facing the north east in the morning to face North West in the afternoon (northern hemisphere).

FIG. 2B. Illustrates a top view of array on a midsummers day turning from the south east in the morning through to the south west in the afternoon sweeping less accentuated conjoined cones.

FIG. 3. Illustrates a below view of an eight panel tracker array.

FIG. 4. Illustrates a side view of the main elements of the apparatus in greater detail.

FIG. 5. Illustrates an entire apparatus mounted to an upright support and depicted in the late afternoon in a westerly facing position (southern hemisphere).

FIG. 6. Illustrates a below view of the apparatus in the midday position and illustrating a different type of linear actuator.

FIG. 7. Illustrates the main components of the apparatus in greater detail and particularly illustrates the main drive to drive the apparatus about the primary north-south axis.

FIGS. 8-11. Illustrate variations of linear actuators to tilt the support frame about the secondary east-west axis in an incremental manner.

FIGS. 12-13. Illustrate variations to the top mount on the pole to which the main mounting member is attached and also illustrates variations to the main mounting member.

### DETAILED DESCRIPTION OF PREFERRED EMBODIMENTS

Note: diagrams (except for FIG. 2A, 2B) refer to trackers deployed in the Southern Hemisphere

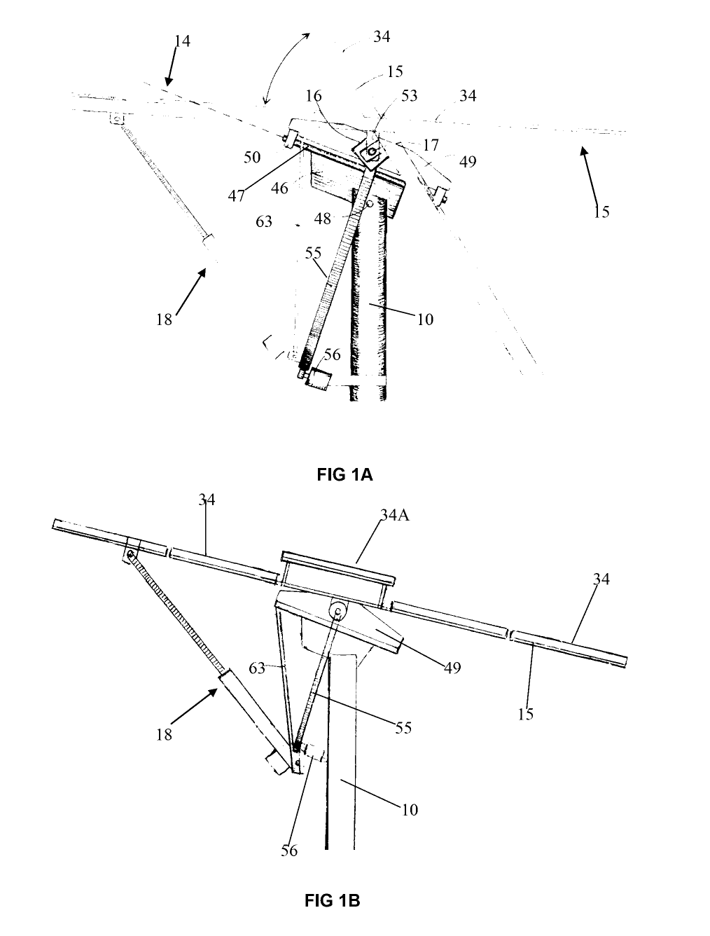

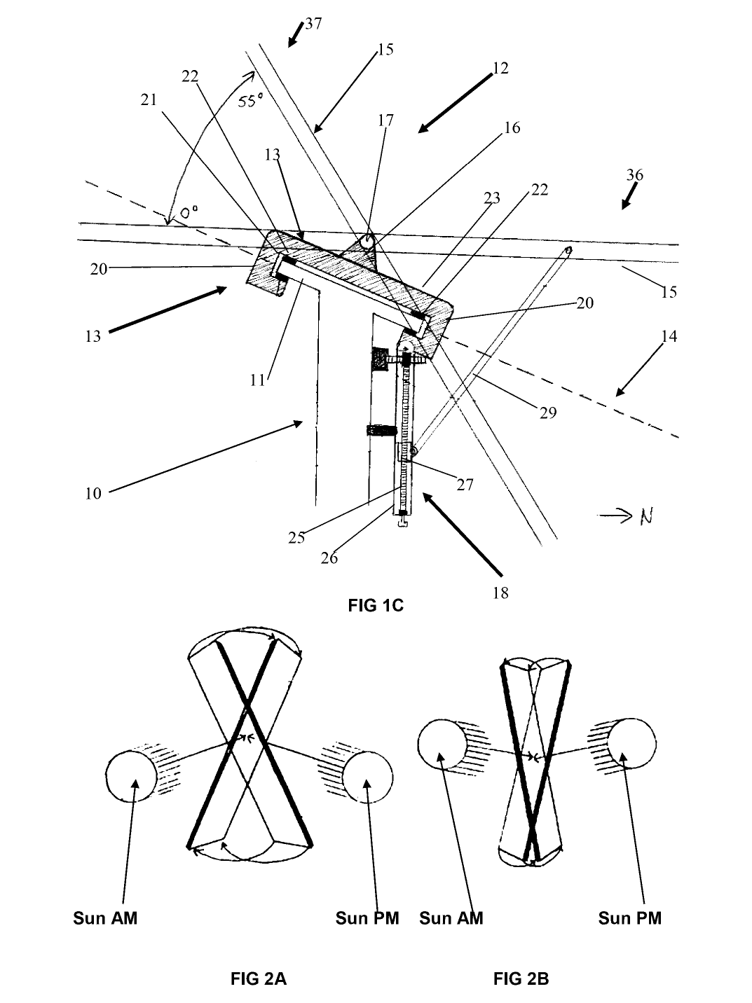

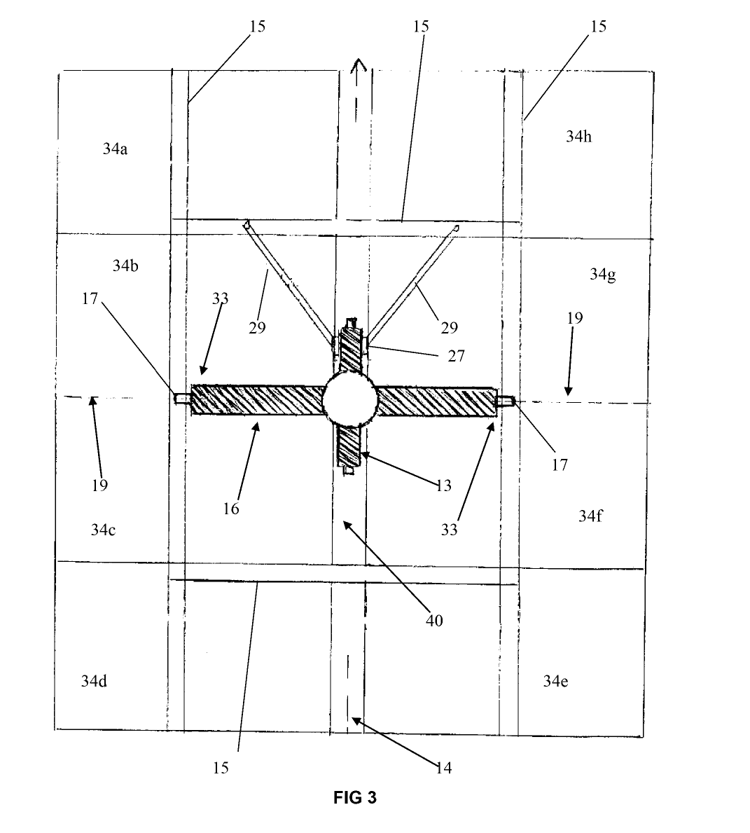

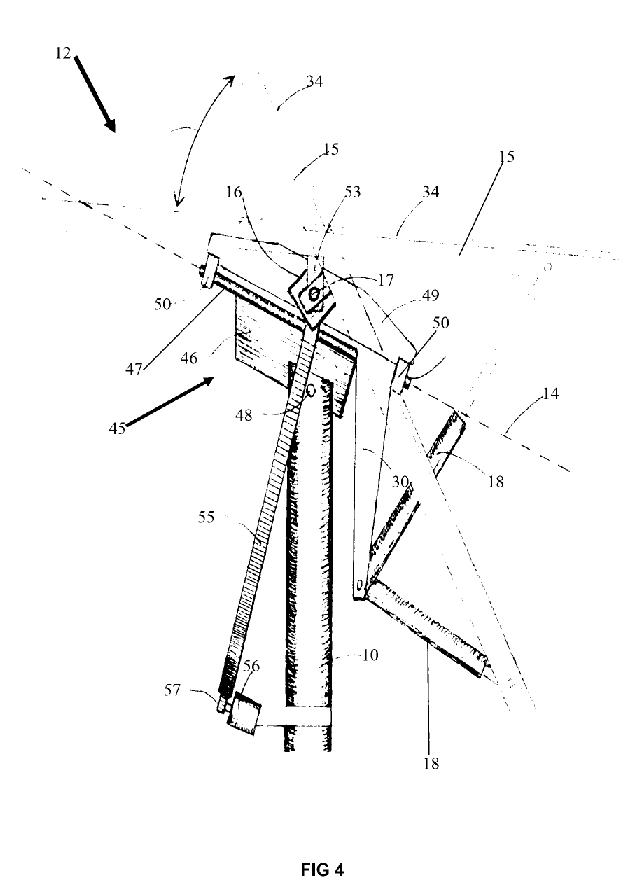

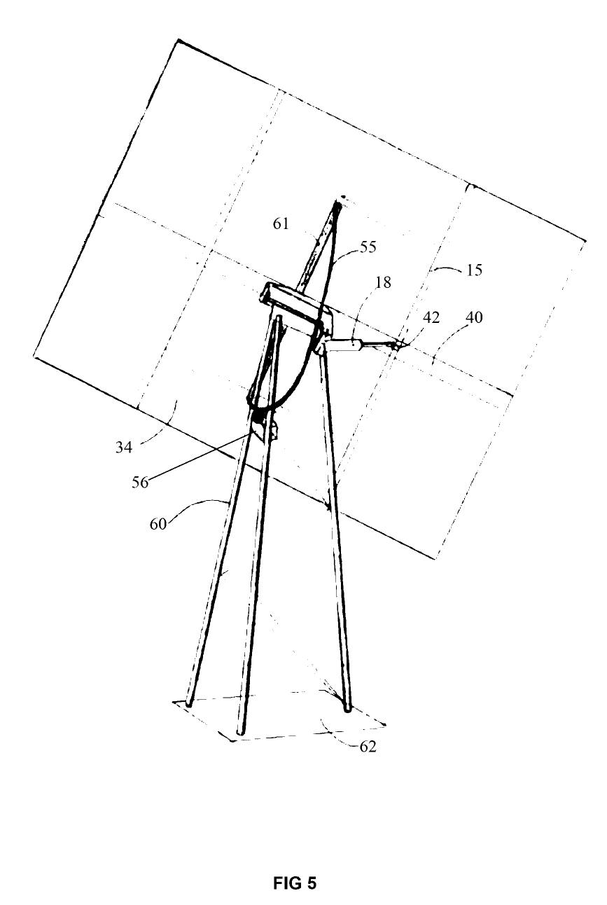

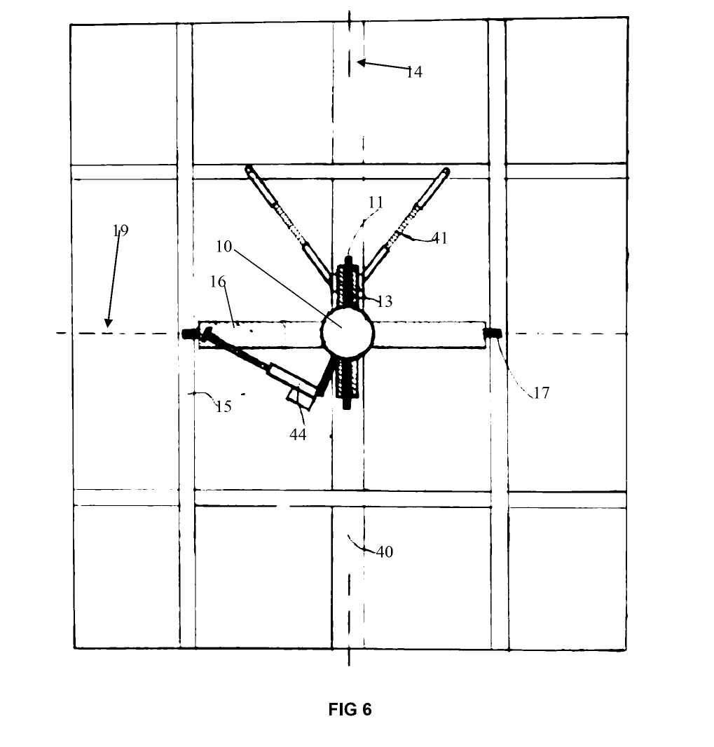

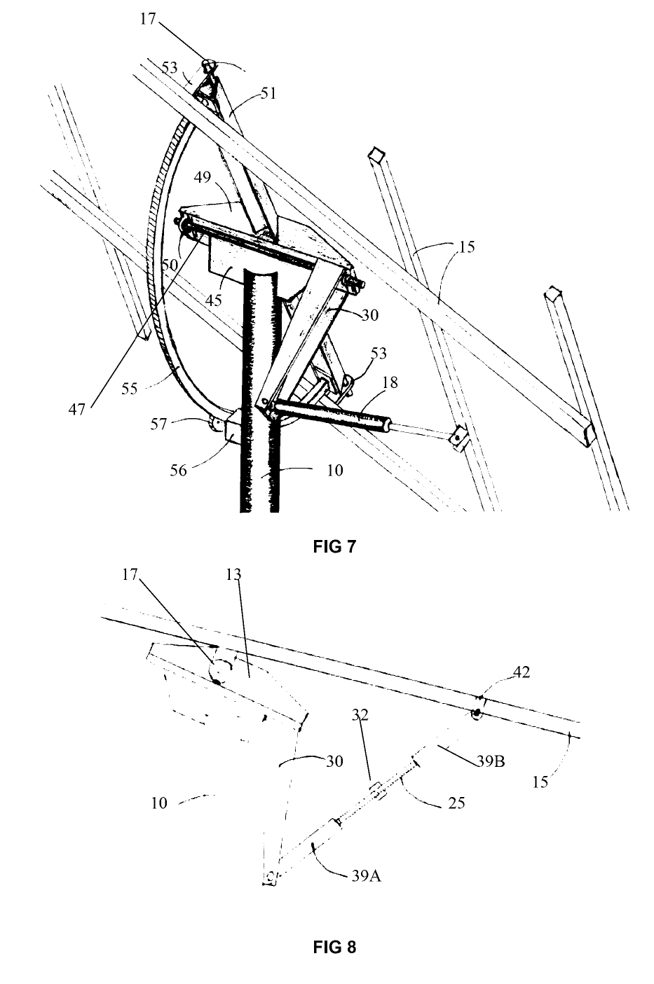

Referring at least to FIGS. 1A-C,4 and 7 there is illustrated a solar tracking apparatus 12 mountable to the top of an upright support in the form of a pole 10, the assembly comprising:
a main mounting member 13, (49 in FIGS. 1A-B and FIGS. 4 and 7) adapted for rotation relative to the upright support about a primary axis 14 defining a north south axis;
a support frame 15 adapted to support solar panels;
attachment means 16 to attach the support frame to the main mounting member;
pivot means 17 to enable the support frame 15 to pivot relative to the attachment means 16 about a secondary axis 19 defining an east west axis (see for example FIG. 3); and,
adjustment means 18 to enable the tilt angle of the support frame to the attachment means to be adjusted.

Referring generally to the apparatus, the apparatus has a latitude dependent, fixed angle primary axis 14 (or with small functional range of movement) oriented north-south, but additionally incorporates an east-west axis 19 (see FIG. 3) above the primary axis 14. Daily the array rotates from east to west over the primary axis 14. Additionally the array is progressively adjusted (for example weekly, monthly or seasonally) and set at the desired inclination by incrementally rotating the array over the secondary axis 19.

The incremental adjustment of this inclination angle about the secondary axis 19 gives the array the ability to follow the sun reasonably accurately (within 10 degrees of normal) for any day of any season. Thus, the tracker works with close to the efficiency of a dual axis tracker but the simplicity of a single axis tracker. The configuration of these axes gives the tracker a unique mode of movement. It means that in summer the southern end of the array is offset below the primary axis and the northern end is offset above the primary axis. Vice versa in winter.

At the top of the pole is attached a main mounting member in the form of a shaft/hinge 13 having a primary north south axis 14 but which is also tilted down at an angle of 18-25 degrees (depending on the latitude) towards the equator. This is the primary axis around which an actuator/driver pushes the array from east in the morning to west in the afternoon. The inclination of this axis is fixed or has very limited range of movement, inter alia, to simplify construction.

The shaft/hinge 13 may be short in length so the array does not contact the top end when in the flattest orientation or the bottom end when most tilted. It is possible to have a longer, more stable hinge, if panels are centrally separated. Preferably the hinge should not protrude significantly above the array face where it could cause shading if backtracking is intended. Alternatively, the solar modules 34A at the centre of the array (above the hinge) could be attached at a higher elevation to the main array to avoid any chance of contact (see FIG. 1B).

A pivot means in the form of a secondary hinge/axis 17 is located immediately above the shaft 13 and is orientated in an east-west direction 19. Incremental tilt adjustments are made around this axis. The adjustment may be anything from daily to seasonal i.e. 365 times a year to 5 times a year. For concentrated solar applications that require greater accuracy than trackers using standard PV panels, this adjustment could be automated and occur within a day

In the manually adjusted embodiments, once the array is adjusted to the next desired tilt angle it is locked in this position. This locking can be executed near the pivot points of the secondary axis or, preferably, by incorporating one or more diagonal braces 29 which extend from the array frame 15 to an arm projecting down from the frame on the lower hinge. Or, a threaded rod and moving nut could simplify and speed up this operation (see FIG. 1C). Alternatively a second linear actuator could be substituted for the bracing arm and threaded rod. The lower end of the actuator would attach to an arm projecting downwards from the lower hinge/shaft frame.

The tracking array and its attachments are centrally balanced above the pole. The weight distribution is such that the array does not topple from side to side when over-centered.

Referring in greater detail to the figures, FIG. 1C illustrates a side view of main elements showing the fixed tilt primary axis/hinge and a cross section of the shaft representing the secondary axis over which inclination is adjusted.

Note that in the summer (flat) setting the southern end of the array frame is offset below the line of the primary axis and the northern end is offset above. Vice Versa for the winter (tilted) setting.

The solar tracking apparatus 12 is fitted to the top of a vertical pole 10. The vertical pole 10 is provided with a top mount in the form of a shaft 11. Shaft 11 is attached to the top of vertical pole 10 by any suitable means and is provided with a predetermined tilt or inclination to accommodate the latitude of the area where the solar tracking apparatus is to be used. Typically, the inclination will be between 18-25°.

The main mounting member 13 is rotatably mounted to shaft 11. In FIG. 1C, main mounting member 13 comprises an elongate main body portion 23 and opposed end walls 20 which contain recesses or sockets 21 to accommodate bearings 22 which rotatably mounts the main mounting member 13 to shaft 11. Because of the north-south orientation of the shaft and also because of the latitude accommodating inclination of the shaft, the main body portion 13 will rotate about the main north-south axis and at the correct latitude accommodating inclination.

Fixed to the main body portion 23 is an attachment means which in the particular embodiment is in the form of a cross arm 16 which is better illustrated in FIG. 3. Cross arm 16 comprises a strong elongate member which, in the particular embodiment, may have a length of between 1-4 m. The cross arm is fixed to the main body portion and cannot move independently of the main body portion. Thus, rotation of the main body portion about the north-south main axis also causes rotation of cross arm 16 as cross arm 16 is fixed to the main body portion.

Cross arm 16 is fixed at right angles to the main body portion and therefore extends along a secondary east-west axis 19. Cross arm 16 is linear and each end 33 of arm 16 is provided with pivot means in the form of pivot pins 17, this being best illustrated in FIG. 3. Pivot pins 17 are axially aligned and define the secondary east-west axis 19.

A support frame 15 is provided to support PV panels or other types of panels or devices that are suited for use with a solar tracking apparatus. The support frame 15 can be made in the usual manner and typically comprises steel or aluminium sections fastened together and connected by interconnecting members.

FIG. 3 illustrates a support frame 15 to accommodate eight PV panels 34a-h but it should be appreciated that this is only according to a nonlimiting embodiment of the invention. The support frame 15 is mounted to the pivot pins 17 such that the support frame 15 (and therefore the panels) are supported only via the pivot pins 17 and are not fixed to any other part of the apparatus. The support frame and PV panel arrangement is such that the entire frame is balanced about pins 17 this functioning to reduce stresses and undesired forces on the apparatus.

Thus, rotation of the main mounting member 13 about the primary north-south axis will cause the support frame (and therefore the PV panels) to rotate between an easterly (morning) facing direction to a westerly (afternoon) facing direction and vice versa.

Another advantage of the solar tracking apparatus of the present invention is the ability to adjust for seasons (seasonal variation) by tilting the PV panels about the secondary east-west axis as the season progresses. Typically, the panels will be tilted at a greater angle in winter (when the Sun is lower in the sky) and at a lesser angle (that is more horizontal) in summer when the Sun is higher in the sky.

Referring to FIG. 1C, the orientation of the support frame/PV panels 36 is a “summer orientation” where the support frame/PV panels are more horizontal, while the orientation illustrated as reference numeral 37 is a “winter orientation” where the PV panels are more tilted. The angle of rotation or tilt between the “summer orientation” and the “winter orientation” will typically be up to 60°.

The support frame and panels are arranged to provide an opening 40 to enable the array to rotate without conflicting with the main mounting member 13.

The adjustment is carried out using an adjusting means which, in the present embodiments, comprises a linear actuator 18. Various types of actuators are envisaged.

A simple type actuator is illustrated in FIG. 8. In this embodiment, a supporting arm 30 is welded or otherwise rigidly attached to the main mounting member 13 to swing with the main mounting member. A threaded sleeve or socket 39A is pivotly attached to a lower end of arm 30 and contains an internal thread. A threaded rod 25 is threadingly engaged into socket 39A. A similar socket 39B is pivotly attached to support frame 15 via a bracket 42 and the other end of threaded rod 25 threadingly engages into socket 39B. A nut 32 is welded or otherwise fixed to the rod. Nut 32 can be replaced by any other type of tool attaching member. A spanner or something similar can be placed over nut 32 and rotated to cause the support frame 15 to tilt. It is also envisaged that nut 32 can be replaced by a hand graspable knob or something similar. Nut 32 alternatively can be a travelling nut. In this alternative, the rod is rotated to the desired extension. The nut is then wound up to lock against one of the sockets 39A or 39B to lock the rod.

An automated type actuator is illustrated in FIG. 9. In this embodiment, a small motor 35 is provided which can rotate rod 25 either out of, or into a sleeve 44.

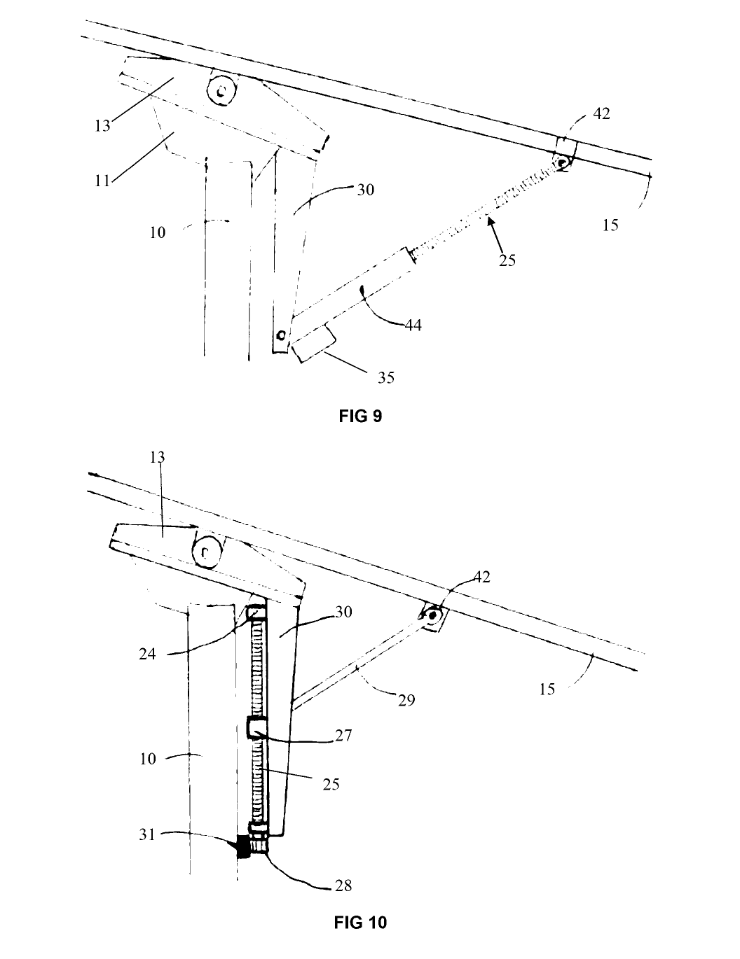

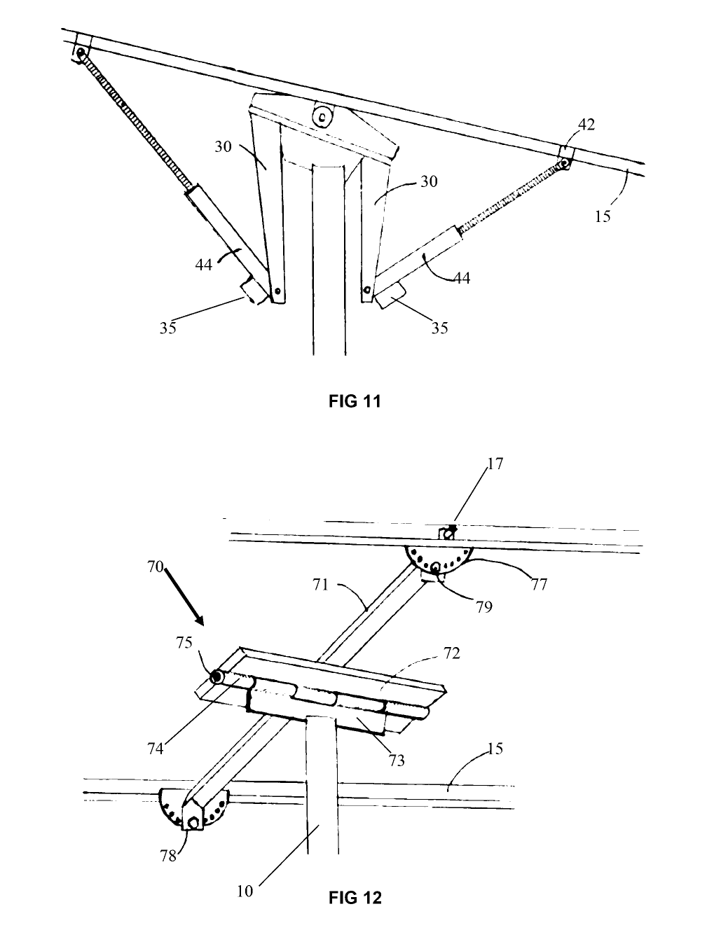

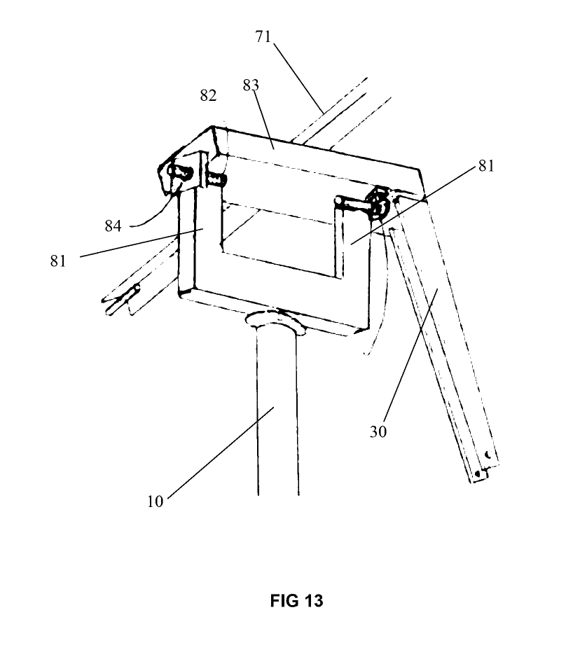

FIG. 10 illustrates an actuator which enables incremental tilt adjustments to be made to the support frame 15 in a purely mechanical manner. In this particular embodiment, the actuator comprises a tilt adjusting drive having a threaded rod 25 rotatable about its longitudinal axis. Each end of rod 25 is journalled at 24 to a depending support arm 30 which is welded or otherwise rigidly attached to the main mounting member 13. The tilt adjusting drive is not fixed to pole 10. Therefore, rotation of the main mounting member 13 about the primary north-south axis will also cause similar rotation of the tilt adjusting drive.

A travelling nut 27 is threadingly engaged to rod 25. Nut 27 does not rotate so rotation of rod 25 in one direction will cause nut 27 to advance along the rod towards the main mounting member 13, and rotation of the rod in the other direction will cause nut 27 to travel down towards the lower end of the rod.

A connecting member in the form of one or more bracing arms 29 has a lower end pivotly attached to nut 27. An upper end of bracing arm 29 is pivotally attached via a bracket 42 to the support frame 15 this being best illustrated in FIG. 10.

In the particular embodiment illustrated in FIG. 3, a pair of bracing arms 29 is provided, a lower end of each being pivotly attached to nut 27 and the upper end of each being attached at spaced apart locations to frame 15.

Rotation of rod 25 to cause advancement of nut 27 results in the support frame 15 (and therefore the panels) being rotated about the secondary east-west axis in one direction and counter rotation of rod 25 to cause downward movements of nut 27 results in the support frame being rotated down in the opposite direction.

FIG. 10 illustrates the addition of a toothed cog 28 welded or otherwise fixed to the bottom of threaded rod 25. Cog 28 strikes a cam or pawl 31 once a day to slightly rotate the cog, and therefor to slightly rotate the rod. This, in turn, causes the nut to incrementally advance or retreat. The cam is fixed to the pole and therefore will advance the cog when the arm 30 containing the rod 25 swings past the pole, this being about at midday. The can adjust the array tilt to match the changing seasons.

FIG. 11 illustrates a further embodiment of the invention comprising a pair of linear actuators of the type generally described and illustrated with reference to FIG. 9. This arrangement can provide extra stability to the solar panel array.

This ability to adjust the tilt angle of the solar array (that is, the PV panels on the support frame 15) about the secondary east-west axis enables seasonal adjustment of the solar array while the solar array continues to move about the latitude adjusted primary north-south axis by virtue of the array being attached to the main mounting member 13. The degree of tilt can be up to 60° from the horizontal.

Another embodiment includes a trip mechanism between the central support and the top of the threaded adjusting drive where, once a day as the arm incorporating the drive passes the central support, the nut on the threaded rod is rotated partially so that in a 6 month period the array frame is pushed from its midsummer extreme to its midwinter extreme.

FIG. 2A illustrates a top down view of array on a midwinters day (in the northern hemisphere) turning from facing the north east in the morning to face the North West in the afternoon.

Note that the array sweeps the shape of two conjoined cones. No other centrally supported tracker does this.

FIG. 2B illustrates a top down view of array on a midsummers day turning from the south east in the morning through to the south west in the afternoon. Sweeping less accentuated conjoined cones.

FIG. 3 illustrates a bottom-up view of an eight panel tracker array and illustrating cross-section of support post 10 under the first frame which hinges on the hinge/shaft representing the primary axis. The second, array frame supporting the panels, pivots on two pins/bearings which are laterally oriented in an E-W direction. The array frame may hang below the pivot points to help balance the weight. The drive system is not illustrated to provide better clarity to the other components, but it should be understood that a drive system will be present.

In this illustration the adjustable bracing arms are shown to be a pair of diagonally fixed arms who's upper ends attach to the array frame and the lower ends attach to a nut which moves up or down on a threaded rod or similar to effect the adjustment. In other versions this could be a single arm pointing in a northerly direction or, a southerly direction or, one each way.

Referring now to FIG. 4 and FIG. 7, there is illustrated in greater detail the upper section of a pole containing the apparatus according to an embodiment of the present invention. The solar tracking apparatus 12 according to the embodiment of FIG. 4 has similarities to that described with reference to the embodiment of FIG. 1 and therefore like references will be used. The apparatus 12 is mounted to the top of a pole 10. On top of the pole is a mount 45. Mount 45 comprises a strong metal plate 46 on top of which is welded a shaft 47. Mount 45 can have its inclination adjusted for latitude and this can be achieved via a pivot bolt 48 which can securely fix and clamp mount 45 when in the correct inclination. It is not expected that the mount will be readjusted for latitude once the solar tracking apparatus has been assembled on the pole. Therefore, mount 45 will be essentially fixed on the latitude angle has been determined.

Pole 10 containing mount 45 is swivelled about its longitudinal axis until such time as the shaft 47 is in the correct north-south primary axis orientation. At that stage, the pole can be fixed to foundations in any suitable manner. In a slight variation, it is envisaged that the top part of the pole containing the mount may be separate from the remainder of the pole and can be swivelled on top of the remainder of the pole until such time as the correct north-south axis has been determined at which stage the top part of the pole can be locked in position.

A main mounting member 49 is pivotly attached relative to shaft 47 via bearings 50 which forces the main mounting member 49 to rotate about the primary axis and at the correct latitude inclination (these being set by the mount 45).

An attachment means is welded or otherwise rigidly fixed to the main mounting member 49. In this particular embodiment, the attachment means comprises a cross arm 51 (best illustrated in FIG. 7) made from angle steel and extending from each side of main mounting member 49. Each side of cross arm 51 is the same length and the same shape such that the cross arm is “balanced” relative to the main mounting member 49. At each end of cross arm 51 is a pivot pin 52 to which is pivotly attached a small bracket 53, and each bracket 53 is welded or otherwise rigidly attached to the support frame 15. Cross arm 51 is positioned at right angles to the primary axis which means that the pivot pins 52 define the secondary east-west axis. Thus, the support frame 15 will pivot relative to the cross arm about the east-west axis.

The primary and secondary axes intersect at or close to the vertical longitudinal axis of the pole to assist in the overall balancing of the apparatus on the pole.

Referring particularly to FIG. 7 but also FIG. 4, there is illustrated a primary drive assembly to rotate the main mounting member about shaft 47 and therefore to rotate the entire array about the primary north-south axis. The drive assembly comprises a semi-circular toothed rack 55. A motor 56 is supported by pole 10 and has an output shaft connected to a cog 57 which engages with rack 55. Thus, operation of motor 56 will cause the rack to move either in a clockwise or anticlockwise manner. An advantage of this particular drive assembly is that rack 55 is attached adjacent each end of the cross arm 51. This provides two lateral points of robust support of the relatively heavy array making it more stable, particularly in windy conditions. The rack is rigidly fixed to the cross arm and therefore moves through a defined area which allows for a simpler and more easily located drive motor 56.

A rigid support arm 30 is welded or otherwise fixed to one end of main mounting member 49. The function of arm 30 is to support part of the adjustment means to tilt the solar array about the secondary east-west axis.

A lower part of arm 30 pivotly supports a linear actuator 58, the other end of actuator 58 being pivotly mounted to part of the support frame 15.

FIGS. 1A and 1B illustrate the preferred forms of the invention. In this preferred form, the adjustment means (linear actuator) 18 is connected at a lower end to the semi-circular toothed rack 55 which forms part of the drive that drives the array about the N-S axis. A small bracing member 63 is rigidly attached between the main mounting member 49 and the bottom of the rack 55. The linear actuator may include one or more of the other adjustment methods referred to in the specification.

FIG. 5 illustrates an embodiment of the invention where the upright support comprises a mast like structure 60. The attachment means comprises a cross arm being a round pipe 61. The structure is supported on foundations 62 which may comprise concrete footings, a concrete block, ground screws or driven steel spikes and the like.

FIG. 6 illustrates an embodiment similar to that illustrated in FIG. 3 and like reference numerals will be used. In the embodiment of FIG. 6, there is illustrated a linear actuator comprising a sleeve 44 and similar to that described with reference to FIG. 9. FIG. 6 further illustrates an alternative adjustment arm mechanism 41 with a threaded rod which can be periodically screwed into and out of threaded sleeves to alter inclination of the array. A second similar arm is installed in a splayed manner to improve stability.

Referring to FIG. 12, there is illustrated an alternative arrangement of the main mounting member and an alternative attachment of the support frame 15 to the attachment means (cross arm) 71. The main mounting member 70 essentially comprises one leaf 72 of a hinge, with the other leaf 73 of the hinge comprising the mount on top of the pole 10 and this leaf 73 is rigidly attached to pole 10. Each leaf 72, 73 is provided with knuckles 74 and a steel pin 75 passes through the knuckles to complete the hinge. The cross arm 71 is fixed at right angles to define the secondary east-west axis and each end of the cross arm contains pins 76 and the support frame 15 is pivotly attached to the pins 76. In this particular embodiment, the adjustment means to tilt and lock the support frame about the secondary east-west axis comprises a pin in slot arrangement illustrated in FIG. 12. The arrangement comprises a semi-circular locking plate 77 containing an array of openings, and each end of the cross arm, as well as containing a pin 76 is provided with a small depending bracket 78 having a single opening through which a bolt 79 can pass to lock the array at a particular inclined orientation. The locking is conducted at each end of the cross arm. As the season progresses, it may be necessary to periodically (perhaps monthly) remove the bolts, adjust the inclination of the support frame 15 and then re-lock the support frame at the new inclination angle.

FIG. 13 illustrates a further embodiment of the mount on top of the pole. In this embodiment, the mount comprises two spaced apart arms 81. Each arm is provided with a short pivot pin 82 to enable a main mounting member 83 to pivot about the mount on top of the pole. A bracket 84 assists in the mounting.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A dual axis solar tracking apparatus mountable at the top of a central support tower, the apparatus comprising:
a main mounting member adapted for rotation relative to the central support tower about a fixed inclined primary axis defining a north south axis;
a support frame adapted to support a component for receiving solar energy;
attachment means to attach the support frame to the main mounting member;
pivot means to enable the support frame to pivot relative to the attachment means about a secondary axis defining an east west axis; and
adjustment means to enable the tilt angle of the support to the attachment means to be adjusted;
whereby, in use, pivoting of the main mounting member about the fixed inclined primary axis causes the support frame to track the sun from east to west and whereby, the support frame is pivoted about the secondary axis for adjusting an inclination of the support frame to accommodate seasonal variations of positions of the sun.

2. The apparatus of claim 1 including a mount at the top of the central support tower, the mount defining the inclined primary axis, the main mounting member being rotatable about the mount thereby causing the main mounting member to rotate about the inclined primary axis.

3. The apparatus of claim 2, wherein the component for receiving solar energy comprises PV panels, solar reflectors, solar heaters or a combination thereof.

4. The apparatus of claim 1, wherein the central support tower comprises a pole, mast or tower.

5. The apparatus of claim 1, wherein the attachment means comprises a cross arm fixed to the main mounting member, the cross arm having opposed ends, each end including a said pivot means to enable the support frame to pivot relative to the attachment means about a secondary axis defining an east west axis.

6. The apparatus of claim 1, wherein the adjustment means comprises at least one linear actuator.

7. The apparatus of claim 6, wherein the linear actuator comprises a threaded rod rotatable about its longitudinal axis, the rod being operatively connected to the support frame, whereby rotation of the rod causes tilting of the support frame.

8. The apparatus of claim 7, wherein the linear actuator comprises a threaded rod, a traveling nut threadingly engaged about the threaded rod, at least one connecting member attached to the nut and to the support frame, whereby rotation of the rod causes movement of the nut along the rod and tilting of the support frame about the secondary axis.

9. The apparatus of claim 7 or 8, wherein the nut passes daily over a cam on the central support tower thereby changing the length of the arm and the inclination of the array frame

10. The apparatus of claim 1 including a drive to drive the apparatus about the primary north-south axis, the drive comprising a rack attached to the attachment means and rotating through a defined arc upon rotation of the apparatus by the drive means, and a motor supported by the central support tower and coupled to the rack for driving thereof.

11. The apparatus of claim 10, wherein the rack is semicircular and is attached to the attachment means adjacent ends of the attachment means to provide robust support for the apparatus.

12. The apparatus of claim 11, wherein the adjustment means comprises a linear actuator having one end attached to the rack and another end attached to the support frame.

13. The apparatus of claim 1, wherein the mount on top of the support and the main mounting member comprise hinge leafs each including at least one knuckle, and a hinge pin extending through the knuckles to hinge the leaf together, the pin defining the primary axis.

14. The apparatus of claim 1, wherein the mount on top of the support is bifurcated, each bifurcated arm supporting a hinge pin, the pins defining the primary axis, the main mounting member being pivotly attached to the pins.

15. The apparatus of claim 1, wherein the adjustment means about the secondary axis comprises a locking plate attached to the support frame with multiple openings to accept a locking bolt, the bolt fixing the support frame to the attachment means at a particular inclination.

16. The apparatus of claim 1, wherein the pivot means to enable the support frame to pivot relative to the attachment means about a secondary axis defining an east west axis is such that the secondary axis intersects at or close to the central vertical longitudinal axis of the pole.

17. The apparatus of claim 16, wherein the support frame and the attachment means and any attached component for receiving solar energy are designed such that the weight is approximately balanced to each side of the secondary axis.
